(19) United States
(12) Patent Application Publication
(10) Pub. No.: US 2009/0120006 A1
(43) Pub. Date: May 14, 2009

(54) Construction apparatus

(76) Inventor: Brent David Vincent, Fresno, CA (US)

Correspondence Address: Rodney K. Worrel;WORREL & WORREL, St. Croix Professional Center, 2109 W. Bullard Avenue, Suite 121, Fresno, CA, 93711-1258, US

(21) Appl. No.: 11/983,751

(22) Filed: Nov. 8, 2007

(51) Int. Cl. E05D 15/08

(52) U.S. Cl. 49/414

(57) ABSTRACT

A construction apparatus having a frame adapted to be mounted on a support; at least one work object, having a predetermined upper portion and a lower portion; and an assembly mounting the work object in supported relation on the frame by the upper portion or the lower portion of the work object for substantially lateral movement relative to the support in the performance of a work operation.

### CROSS-REFERENCE TO RELATED APPLICATIONS

Not applicable.

### STATEMENT REGARDING FEDERALLY SPONSORED RESEARCH OR DEVELOPMENT

Not Applicable.

### BACKGROUND OF THE INVENTION

(1) Field of the Invention

The present invention relates to a construction apparatus and, more particularly, to a construction apparatus which is unusually well suited to use in those environments in which the capability for installation at a rapid pace while providing a precision of operation and dependability of use are of substantial importance.

(2) Description of the Prior Art

In many environments, there are competing considerations which tend to be in conflict during installation of a work object or the like and the subsequent use thereof. For example, in the construction industry the cost of the product, the ease of installation, the labor expenses, the precision of construction and dependability in use, among others, are often in direct conflict. In fact, in a relative sense, conventionally such considerations are mutually exclusive. Thus, the purchase price of a completed home, or another type of structure, is one of the most immediate concerns to a potential buyer. Those considerations which permit a lower purchase price frequently prevail over concerns such as precision of construction, attractive appearance, dependability of use, operational durability and the like.

More specifically, for example, the housing industry is replete with conflicting concerns of this type. Nearly every aspect of housing construction is dependent upon such decisions. Since, for the reasons stated, the purchase price is, in large part, controlling in the marketplace, other considerations must frequently be sacrificed in order to achieve a lower purchase price. This tends to be the case at all levels of the housing market. Over the years, a wide variety of products including, but not limited to, prefabricated components have been developed as well as more expedient methods of construction. However, there continues to be a desire to satisfy all of these considerations. Unfortunately, success in these regards has proved elusive and this dichotomy continues to exist.

This is particularly the case with respect to components and other structures which are frequently used in homes, or are otherwise exposed to view on a frequent basis. Doors, windows, closets, and other structures, both internally and externally of homes, are examples thereof. The high visibility, frequency of use and reliance thereon reveals such undesirable characteristics. Most homes are constructed in large scale developments with all of the homes being constructed at a more or less continuous rate. The installation of prefabricated components and the like is thus repeated on a continuous basis.

For example, in the case of prefabricated, or partially prefabricated, sliding doors such as used for wardrobe closets, it is known to mount mirrored surfaces on the exteriors thereof. This form of construction is also used on other structures. Such construction, among other benefits, affords a convenience of use and conserves space in, for example, bedrooms as well as other areas of a house. However, in conventional construction such assemblies are difficult to install. They are, consequently, often improperly installed by construction workers. In this event, they cannot be operated as designed and intended. Where properly installed, such structures readily fail during use so as to require frequent adjustment, repair, replacement of parts and other attention. In any case, such conventional assemblies are unsatisfactory in many respects.

Therefore, it has long been known that it would be desirable to have a construction apparatus having application in a variety of environments which avoids the pitfalls experienced with conventional devices; which has particular utility when used in the case of sliding doors and the like; which is less expensive than conventional devices; which can rapidly and dependably be installed without undue instruction or supervision; which is of durable and dependable construction so as to provide a long operational life with little or no repair or other attention required; and which is otherwise entirely successful in achieving its operational objectives.

### BRIEF SUMMARY OF THE INVENTION

Therefore, it is an object of the present invention to provide an improved construction apparatus having particular utility when employed in new construction as well as when installed thereafter.

Another object is to provide such a construction apparatus which has application to a wide variety of working environments, particularly where it is necessary to mount one or more work objects for movement along one or more paths of travel.

Another object is to provide such a construction apparatus which is adapted for rapid assembly and installation.

Another object is to provide such a construction apparatus which is particularly well suited to use in the construction of homes and other structures where it is desired to require a minimal period of time for installation and completion and so as similarly to reduce the labor expenses required therefore.

Another object is to provide such a construction apparatus which is more durable and dependable than has heretofore been possible with prior art devices intended for similar purposes.

Another object is to provide such a construction apparatus which substantially avoids the need for frequent adjustment and repair such as required by prior art devices employed for the same or similar purposes.

Another object is to provide such a construction apparatus having particular utility in combining the benefits of at least two uses in a single device which, in such use, complement each other so as to require a minimum amount of space and convenience of use while having an ease and dependability of operation.

Another object is to provide such a construction apparatus which readily works in conjunction with prior art devices to accrue all of the benefits thereof including, but not limited to, familiarity of installation, operation and use.

Another object is to provide such a construction apparatus which can be manufactured and sold at less cost than has heretofore been possible with prior art devices intended for similar purposes.

Further objects and advantages are to provide improved elements and arrangements thereof in an apparatus for the purpose described which is dependable, economical, durable and fully effective in accomplishing its intended purposes.

These and other objects and advantages are achieved, in the preferred embodiment of the present invention, in a construction apparatus having a frame adapted to be mounted on a means of support; at least one work object, having a predetermined upper portion and a lower portion; and an assembly mounting the work object in supported relation on the frame by the upper portion of the work object for substantially lateral movement relative to the means of support in the performance of a work operation.

### BRIEF DESCRIPTION OF THE SEVERAL VIEWS OF THE DRAWINGS

FIG. 1 is a fragmentary, perspective view of the construction apparatus of the present invention shown in a typical operative environment.

FIG. 2 is a somewhat enlarged, fragmentary, transverse vertical section taken on line 2-2 in FIG. 1.

FIG. 3 is a somewhat enlarged, fragmentary, horizontal section taken on line 3-3 in FIG. 1.

FIG. 4 is a fragmentary, perspective view of a portion of the construction apparatus of the present invention.

FIG. 5 is an enlarged, fragmentary perspective view of a portion of the construction apparatus viewed on the left, as shown in FIG. 4.

FIG. 6 is a fragmentary, perspective view of a portion of the construction apparatus viewed from the opposite side thereof shown in FIG. 5.

FIG. 7 is a fragmentary, exploded, perspective view of the portion of the construction apparatus viewed in FIG. 6.

### DETAILED DESCRIPTION OF THE INVENTION

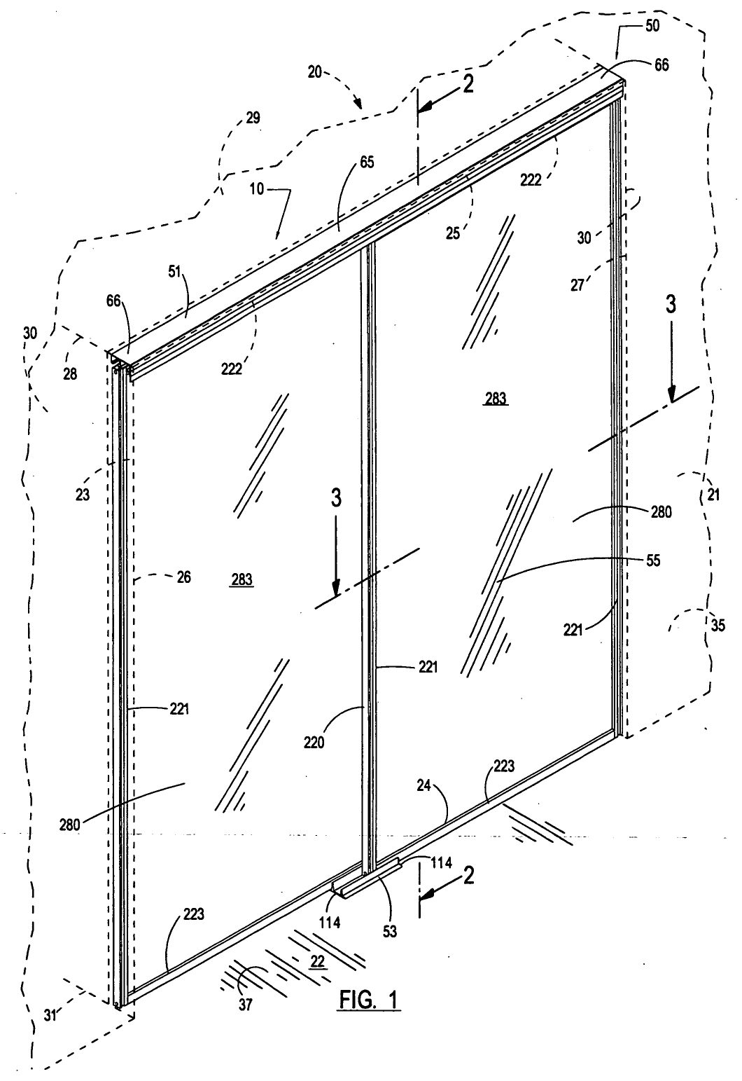

Referring more particularly to the drawings, the construction apparatus of the present invention is generally indicated by the numeral 10 in FIG. 1.

The construction apparatus 10 is adapted for use in a variety of environments. A representative operative environment is shown is the drawings and described herein. The operative environment is a structure generally indicated by the numeral 20 in FIG. 1. The structure can be visualized as being a house which is under construction. The structure has a substantially vertical wall 21 which can be visualized as an interior wall of the structure. The structure has a substantially horizontal floor 22. A substantially rectangular wall opening 23 extends through the wall oriented along a path which is substantially right-angularly related to the wall.

The wall opening 23 has a bottom side surface 24 and a top side surface 25 which is substantially parallel to the bottom side surface. The wall opening has a left side 26 and a right side 27 which is substantially parallel to the left side. The bottom side is disposed in upwardly facing, horizontal relation along a plane which is substantially continuous with the floor 22. The top side, the left side and the right side face forwardly in right-angular relation to the bottom side. The wall opening, in this representative operative environment, leads into and thus communicates with a wardrobe closet 28. The wardrobe closet has a substantially flat and horizontal upper wall 29. A pair of side walls 30 extend downwardly from the upper wall at substantially right-angles thereto and in spaced, substantially parallel relation to each other. The side walls of the wardrobe closet extend downwardly to a floor 31 of the closet disposed in substantially right-angular relation thereto.

The wall 21 has a substantially flat wall surface 35. The floor 22 has a floor surface 37.

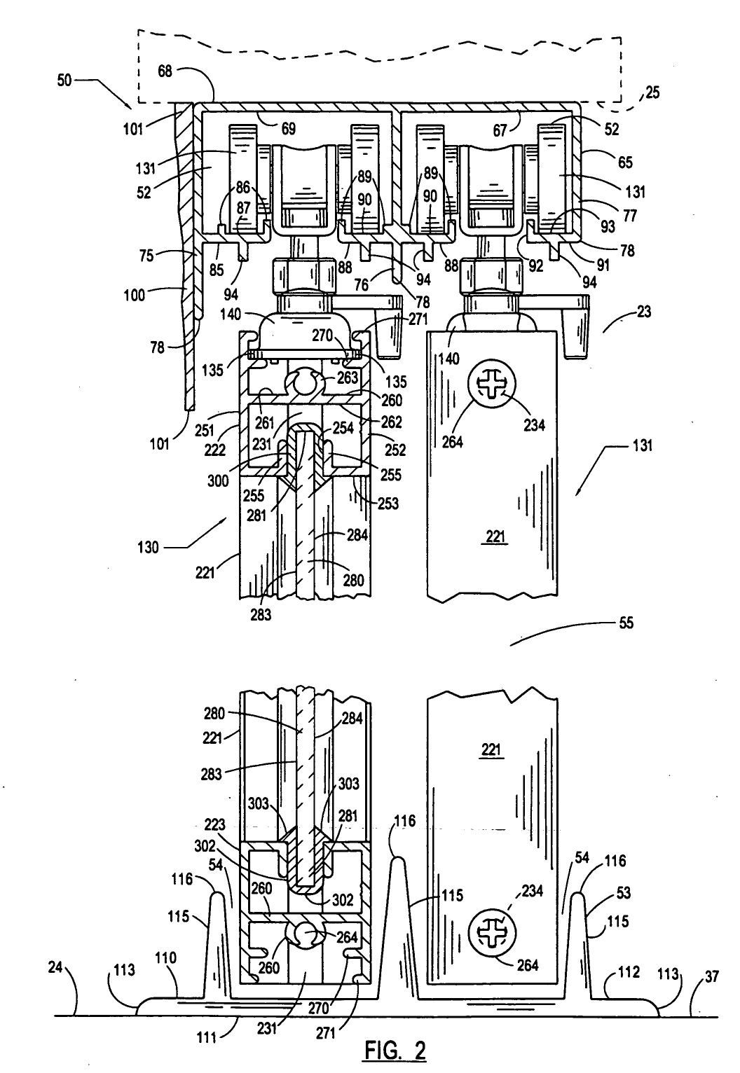

The construction apparatus 10 has a main frame generally indicated by the numeral 50 in FIG. 1. The main frame has an upper frame assembly 51 defining a pair of tracks 52 therewithin. The main frame has a lower frame or guide assembly 53 defining two (2) guide passages 54 therewithin. It will be noted, as shown in FIGS. 1 and 2 and as will hereinafter be discussed in greater detail, that the upper frame assembly 51 and the lower guide assembly 53 are spaced from each other a predetermined distance and are not interconnected. The upper frame assembly 51 and lower guide assembly 53 define a work area or path of travel 55 therebetween.

The upper frame assembly 51 has a support beam 65 having opposite end portions 66. In the operative environment shown best in FIG. 1, the support beam is mounted by any suitable means on the top side 25 of the wall opening 23. The support beam is mounted on the top side so as to extend substantially horizontally therealong and downwardly from the top side, as best shown in FIG. 2.

The support beam 65 has an upper portion 67 having an upper surface 68 which is mounted in facing engagement with the top side of the wall opening 23. The upper portion of the support beam has an interior surface 69 which faces downwardly from the upper portion 67 of the support beam. A first vertical flange 75, a second vertical flange 76 and a third vertical flange 77 are mounted on and extend downwardly from the interior surface of the upper portion of the support beam in predetermined spaced relation to each other, as shown in FIG. 2. The first, second and third vertical flanges extend the complete length of the support beam 65 interconnecting the opposite end portions 66 thereof. The first, second and third vertical flanges extend downwardly to terminal ends 78. As shown in FIG. 2, the first, second and third vertical flanges are, in that order, of progressively shorter length. The adjacent first, second and third vertical flanges define the track passages 52 therebetween. Thus, there are two (2) track passages extending in side-by-side relation the full length of the support beam 65. The two (2) track passage are individually of the same width.

The first vertical flange 75 has a track member 85 mounted thereon and extending toward the second vertical flange 76 disposed in horizontal relation. The track member extends the entire length of the first vertical flange. The track member 85 mounts two (2) upwardly extending ribs 86 disposed in predetermined spaced relation to each other to define an upwardly facing wheel track 87 therebetween. The wheel track extends the complete length of the first vertical flange.

The second vertical flange 76 has two (2) track members 88, the first track member is mounted on and extends to the left, as viewed in FIG. 2, toward the track member 88 of the first vertical flange 75. The second track member is mounted on the second vertical flange and extends to the right, as viewed in FIG. 2. Each track member mounts two (2) upwardly extending ribs 89 disposed in predetermined spaced relation to each other to define an upwardly facing wheel track 90 therebetween. The ribs nearest the second vertical flange are integral with and extensions from the second vertical flange in opposite directions, as viewed in FIG. 2. Each wheel track extends the complete length of the second vertical flange.

The third vertical flange 77 mounts a single track member 91 which extends to the left, as viewed in FIG. 2, toward the nearest track member 88 of the second vertical flange 76. The track member 91 mounts one (1) upwardly extending rib 92 disposed in predetermined spaced relation to the third vertical flange to define an upwardly facing wheel track 93 therebetween. The wheel track extends the complete length of the third vertical flange.

The track members 85, 88 and 91 individually mount downwardly extending reinforcement ribs 94 which extend the full length of their respective track members, as shown in FIG. 2, the track members 85, 88 and 91, and thus their respective wheel tracks 87, 90 and 93, are disposed in the same horizontal plane.

A facia member, or cover plate 100 is mounted on the first vertical flange 75 facing outwardly therefrom. The cover plate has opposite lateral edges 101 and extends the complete length of the first vertical flange.

The lower guide assembly 53, as previously discussed, is mounted on the bottom side 24 of the wall opening 23. The lower guide assembly has a base plate 110 having a bottom surface 111, a top surface 112 and opposite lateral edges 113. The base plate has opposite end edges 114.

The base plate 110 mounts three upstanding walls 115 disposed in predetermined spaced relation to the adjacent upstanding wall to define the two (2) guide passages 54 therebetween. The walls extend upwardly from the top surface 112 of the base plate to terminal ends 116. As shown in FIG. 2, the terminal end of the wall 115 in the center is higher than the terminal ends of the walls to the left and right thereof. The two (2) guide passages are of the same length.

Two (2) closures or door assemblies 130 are individually mounted, as will hereinafter be described, in their respective track passages 52. The guide passages 54 of the guide assembly 53 are individually, vertically aligned with their respective track passages 52. Thus, when the door assemblies are in the closed positions shown in FIG. 1, the lower ends of the door assemblies are individually received in their respective guide passages suspended immediately above the top surface 112 of the base plate 110. Similarly, the lower ends of the door assemblies are immediately laterally disposed relative to the adjacent walls 115 of the guide assembly so as to be freely moveable within their respective guide passages. When the door assemblies are moved toward the closed positions, the lower ends pass out of the guide assembly 53 so as to be suspended above the floor surface 37 a vertical distance which can be visualized upon reference to FIG. 2.

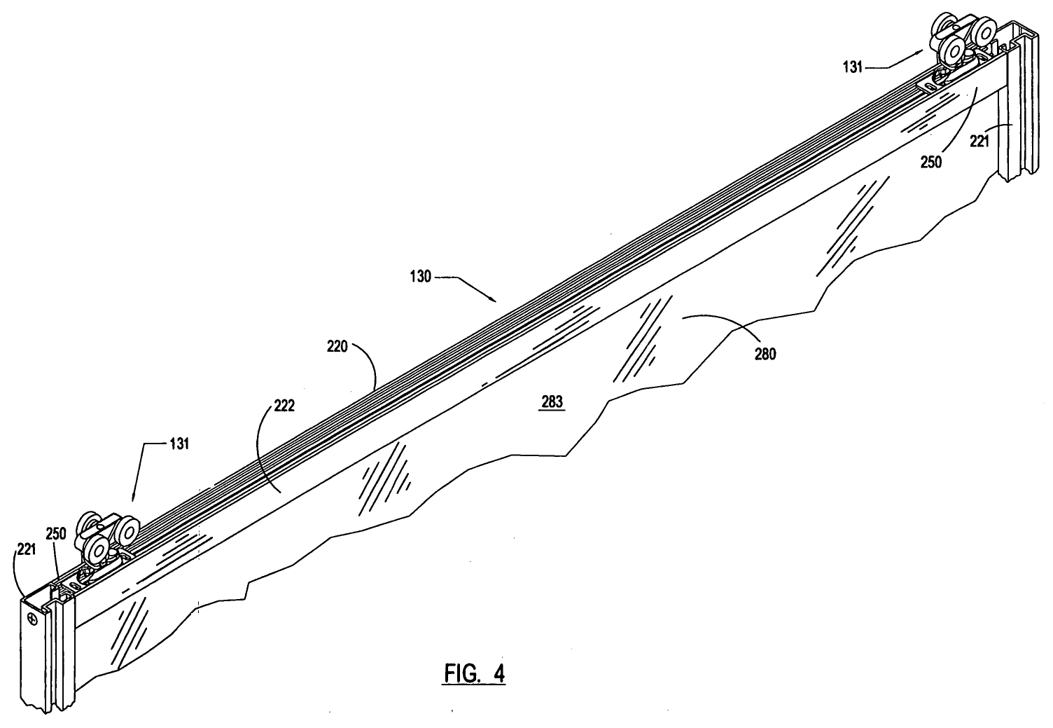

Each door assembly 130 is borne by two (2) carrier assemblies for horizontal movement suspended from their respective track members 85, 88 and 91. The two (2) carrier assemblies of each door assembly are preferably, although not necessarily, spaced from each other a distance as can best be visualized upon reference to FIG. 4.

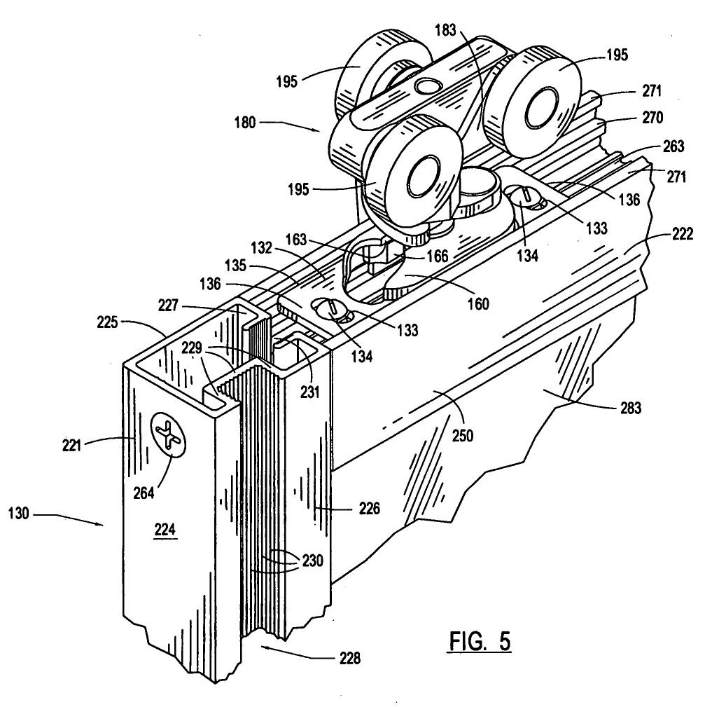

One such carrier assembly 131 is shown in FIGS. 5, 6 and 7. Each carrier assembly has a mounting plate 132 on which its respective door assembly 130 is mounted in suspended relation. The mounting plate has two (2) laterally elongated screw holes 133 through which mounting screws 134 are individually extended to mount the door assembly thereon. The mounting plate has substantially parallel lateral edges 135 and substantially parallel end edges 136.

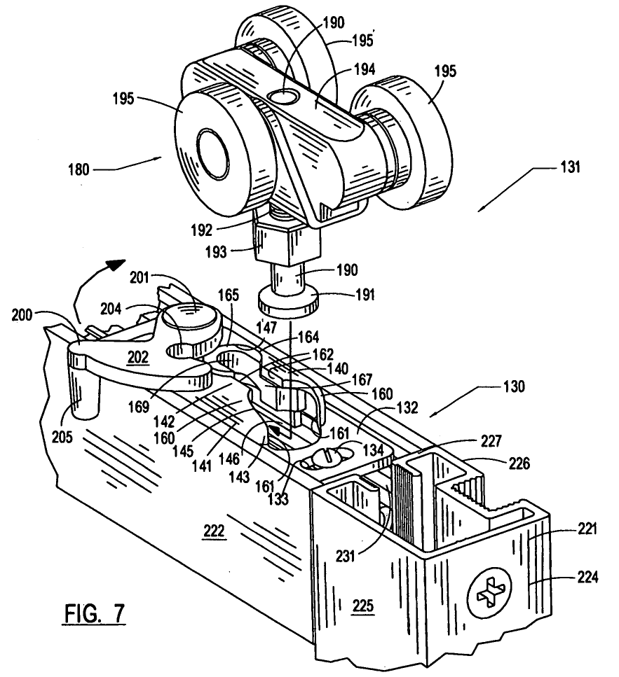

The mounting plate 132 has an elevated central housing 140 extending longitudinally of the mounting plate and shown best in FIGS. 2, 5, and 7. The central housing has upstanding side walls 141 and a continuous, substantially horizontal top wall 142. Referring more particularly to FIG. 7, the central housing has a receiving end portion 143 and an opposite locking end portion 144. A guide slot 145 extends through the receiving end portion of the central housing and through the top wall thereof to the locking end portion of the central housing. The guide slot has a receiving end portion 146 and an opposite locking end portion 147.

The top wall 142 of the central housing 140 has opposite shoulders 160 at the receiving end portion 143 thereof and having convergent guide edges 161. The convergent guide edges individually communicate with parallel guide edges 162 defining a slot 163 therebetween. The slot leads to and communicates with a receiving opening 164 in the top wall.

A bearing insert 165 is mounted in the top wall 142 within the slot 163 and receiving opening 164. The bearing insert is constructed of a material having a low coefficient of friction such as Teflon or the like. The bearing insert has opposite side portions 166 defining a guide passage 167 therebetween. The bearing insert has a receiving portion 168 defining a U-shaped receiving opening 169 therewithin. The bearing insert is held in position by support members 170, as will hereinafter be discussed in greater detail.

Each carrier assembly 131 has a wheel assembly 180, perhaps best shown in FIG. 7. The wheel assembly has a mounting member 181 which has an upwardly facing transversely U-shaped passage 182. The U-shaped passage is defined by wheel mounting flanges 183 which are mounted on an upwardly facing base plate 184 extending therebetween. A mounting shaft 190 is mounted on and extends downwardly from the base plate and the distal end thereof has a radially extending slide member 191. The proximal end portion of the mounting shaft has screw threads 192 extending thereabout on which is screw threadably received a lock nut 193. The lock nut is moveable upwardly and downwardly along the screw threads.

As shown in FIGS. 5, 6 and 7, a body member 194 is mounted in the U-shaped passage 182 of the mounting member 181. The proximal end portion of the counting shaft 190 extends through the base plate 184 and is mounted in the body member. Two (2) wheels 195 are rotationally mounted on one of the wheel mounting flanges 183 and one (1) wheel 195 is rotationally mounted on the other wheel mounting flange. The wheels are preferably, although not necessarily, made of a material having a low coefficient of friction, such as Teflon or the like.

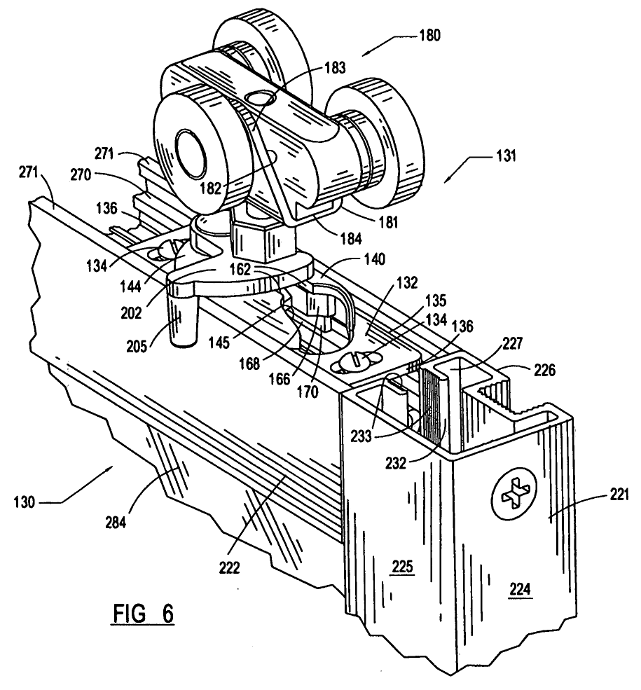

A fastening assembly 200 is mounted on the locking end portion 144 of the central housing 140. The fastening assembly has a pivot pin 201 on which is pivotally mounted a latch member 202. The latch member has a receiving passage 204 and a handle 205. The latch member is mounted on the pivot pin for movement between an unlatched position shown in FIG. 7 and a latched position shown in FIG. 6.

The two (2) door assemblies 130 are shown in closed positions in FIG. 1. The door assemblies are of the same construction except where otherwise discussed. Consequently, for illustrative convenience, the construction of a single door assembly will be described herein.

The door assembly 130 has a rectangular frame 220 mounted on and extending in supported relation downwardly from two (2) carrier assemblies 131. The rectangular frame has two (2) spaced, substantially parallel vertical members 221. The rectangular frame has an upper horizontal member 222, which interconnects the upper ends of the vertical members 221, and a lower horizontal member 223, which interconnects the lower ends of the vertical members. The vertical members are substantially identical, except as herein described. Similarly, the upper and lower horizontal members are substantially identical, except as herein described.

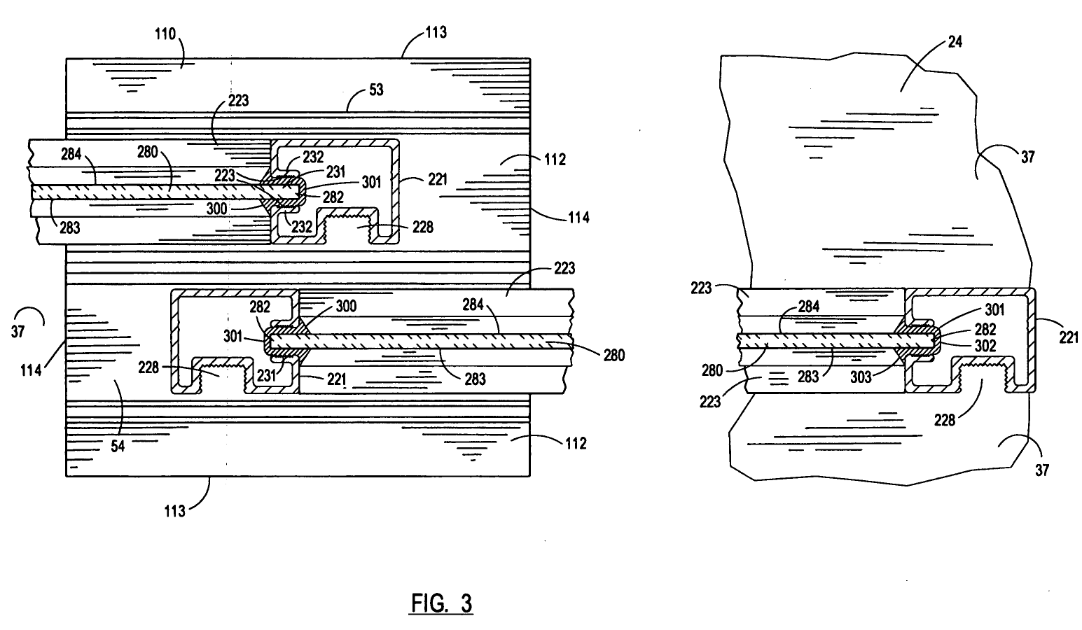

The vertical members 221 are best shown in FIGS. 3, 5, 6 and 7. Since the vertical members are substantially identical, for illustrative convenience one vertical member is described herein. The vertical member has a side wall 224, a back wall 225 and a front wall 227. The front wall 226 has a gripping recess 228 defined by three (3) inwardly facing recess walls 229. The recess walls each bear a plurality of vertical ribs 230 extending the full vertical length of the front wall 226. The interior wall 227 has a vertical slot 231, which extends the entire length of the interior wall, and is defined by inwardly extending, parallel secondary walls 232. The secondary walls each bear a plurality of vertically extending gripping surfaces 233 which extend the full length of the secondary walls.

Screw holes 234 extend through each end of the side wall 224 in predetermined positions, such as shown in FIG. 2.

Since the upper horizontal member 222 and the lower horizontal member 223 are substantially identical, except as herein described, for illustrative convenience, one of these upper and one of these lower horizontal members are described herein. As best shown in FIG. 2, one difference between the two horizontal members is that the upper horizontal member faces downwardly and the lower horizontal member faces upwardly. For reference purposes, except as otherwise described herein, it will be understood that the upper horizontal member is the one to which reference is specifically made.

One additional difference between the upper horizontal member 222 and the lower horizontal member 223 is that the upper horizontal member is mounted on and suspended downwardly from the lateral edges 135 of the mounting plates 132 of the carrier assemblies 131. This is best shown in FIG. 2. Conversely, the lower horizontal member 223 is suspended within one of the guide passages 54 of the guide assembly 53 for lateral movement therewithin. The lower horizontal member is not in any way physically mounted on the guide assembly or any other structure, except as hereinafter discussed.

The upper horizontal member 222 has opposite end portions 250, as best shown in FIG. 4. The upper horizontal member has a front side wall 251 and a rear side wall 252. The upper horizontal member has a boarder wall 253 having a horizontal slot 254 which extends the entire length of upper horizontal member. The boarder wall has two (2) internal flanges which extend in spaced, substantially parallel relation bordering and on opposite sides of the horizontal slot 254, as best shown in FIG. 2. The horizontal slot is of a predetermined width, as will hereinafter be discussed in greater detail.

The upper horizontal member 222 has an internal wall which is mounted on and extends between the front side wall 251 and rear side wall 252. The internal wall has a first surface 261 and an opposite second surface 262. An internally screw threaded tube 263 is mounted on the first surface of the internal wall substantially centrally thereof and extending longitudinally of the internal wall a predetermined distance. The vertical members 221 are mounted on and at the opposite end portions 250 of the upper horizontal member 222 and lower horizontal member 223 to form the rectangular frame 220. Such mounting of the vertical members, upper horizontal member and lower horizontal member is achieved by a screw 264 individually extending through each of the screw holes 234 and screw threadably tightened into its respective internally screw threaded tube 263. The screws are tightened to form a ridged rectangular frame.

The upper horizontal member 222 has two (2) support rails 270 which extend toward each other substantially in a common horizontal plane. The upper horizontal member has two (2) capturing rails 271 disposed in predetermined spaced relation to their respective support rails. The respective capturing rails extend toward each other substantially in a common horizontal plane. The support rails and the capturing rails extend the full length of their respective upper horizontal member 222 and lower horizontal member 223. The mounting screws 134 of the mounting plate 132 of the carrier assemblies 131 are screw threadably secured in suitable vertical, internally screw threaded openings, not shown, in the screw threaded tube 263 of the internal wall 260. The mounting plate is thereby mounted in fixed position on the upper horizontal member 222.

As shown in FIG. 2, the lower horizontal member 223 is inverted relative to the upper horizontal member 223. The lower horizontal member does not mount a carrier assembly 131 thereon. As previously discussed, in all other respects the lower horizontal member has the same construction as the upper horizontal member and is mounted in substantially parallel relation thereto extending between the vertical members 221.

Each of the door assemblies 130 has a closure panel 280 mounted within the rectangular frame 220 for movement therewith along the path of travel 55 of the main frame 50. Each of the closure panels has substantially parallel horizontal edges 281 and substantially parallel vertical edges 282 disposed at right angles to the horizontal edges. Each of the closure panels has a front surface 283 and an opposite rear surface 284. In the preferred embodiment of the invention, the closure panel is glass, the front surface is a mirrored surface and the rear surface 284 is an opaque surface forming a backing for the mirrored surface.

Two (2) horizontal mounting members 300 are individually mounted on the horizontal edges 281 of the closure panel 280. Two (2) vertical mounting members are individually mounted on the vertical edges 282 of the closure panel. The horizontal and vertical mounting members have rear portions 302 which are individually received respectively in the horizontal slots 254 and the vertical slots 231. The horizontal and vertical mounting members have forward portions 303 which engage their respective interior walls 227 and the boarder walls 253 to provide a seal therewith. The horizontal and vertical mounting members are resilient so as to mount the closure panel in the rectangular frame 220 and to provide sealing engagement of the closure panel in the rectangular frame.

### Operation

The operation of the described embodiment of the subject invention is believed to be clearly apparent and is briefly summarized at this point.

Once installed, each of the door assemblies 130 is movable along the path of travel 55 in both horizontal directions of travel in offset relation to each other, as shown in FIG. 2. Accordingly, the door assemblies are movable to and from the closed positions shown in FIG. 1 to opened positions wherein either door assembly is disposed in overlapping relation to the other thus providing access to the wardrobe closet 28.

One of the benefits of the construction apparatus 10 of the present invention is that manufacture thereof is facilitated thereby making the cost of such manufacture less than with conventional methods. In addition, the construction apparatus requires fewer components as well as less construction material than in the case of conventional devices. Still further, the construction apparatus of the present invention can be constructed and assembled entirely off site and within the manufacturing plant.

The construction apparatus 10 can then be delivered to the construction site in a fully assembled condition. Alternatively, the door assemblies 130 can temporarily be removed for ease of transport to the construction site. The door assemblies can be removed from the main frame 50 by simply moving the door assemblies laterally therein on their respective carrier assemblies 131 and from the opposite end portions 66 of the support beam 65. Once delivered to the construction site, at the appropriate time and location the door assemblies can readily be moved to their assembled positions by a reversal of the foregoing process.

Installation of the construction apparatus 10 is readily achieved at the appropriate stage of construction of the structure 20. Once the wall opening 23 is constructed the construction apparatus is moved into the installed position within the wall opening shown in FIGS. 1, 2 and 3. The upper frame assembly 51 is mounted on the top side 25, left side 26 and right side 27 by any suitable means. Preferably, although not necessarily, the construction apparatus is fully recessed within the wall opening, as best shown in FIG. 2. In this installed position, the left side 26 and right side 27 of the wall opening capture the door assemblies 130 and the carrier assemblies 131, from which the door assemblies are suspended, within the wall opening. Preferably, although not necessarily, this installed position places the cover plate 100 flush with the wall 21, as shown in FIG. 2.

The base plate 110, in a mounted position, is installed by any suitable means, on the floor surface 37 immediately beneath the lower horizontal members 223 of the door assemblies 130. More specifically, the lower horizontal members are individually received in the guide passages 54 of the guide assembly 53 so as to be in the configuration shown in FIGS. 2 and 3. The bottoms of the door assemblies 130 are thus individually captured in the guide passages 54 and between the guide assembly and the upper frame assembly 51.

In use, the door assemblies 130 are individually movable from the closed positions shown in FIG. 1 to fully opened positions with door assemblies in overlapping positions, or any positions therebetween. As shown in FIG. 3, even when the doors are in their fully opened positions, a portion of the bottoms of the door assemblies are in their respective guide passages 54. Thus, the door assemblies are retained in parallel vertical attitudes even though the bottoms of the door assemblies are not in anyway secured to or mounted on the guide assembly or floor surface 37.

Individual movement of the respective door assemblies 130 are moved to any positions between the closed positions shown in FIG. 1 and fully opened positions by grasping the gripping recesses 228 and moving the door assemblies to the desired positions.

The carrier assemblies 131 operate both to support the door assemblies 130 in their respective suspended attitudes as well as to permit individual movement of the door assemblies between their respective closed and fully opened positions. The wheels 195 of the carrier assemblies ride in their respective wheel tracks 90 permitting rolling movement of the wheels therein. The door assemblies are normally locked in their described operative positions by their respective fastening assemblies 200, as best shown in FIGS. 5 and 6. If it is desired to remove either door, the latch members 202 of the fastening assemblies 200 are pivoted about their respective pivot pins 201 to their respective release positions shown in FIG. 7. The door assembly is then grasped and moved to the left, as viewed in FIG. 7. This causes the mounting shaft 190 to be transported in relative movement along the slot 163 until they pass through the receiving end portion 146 of the guide slot. The door assembly is then free to be pulled from the carrier assemblies and thus the door assemblies from the upper frame assembly 51.

Therefore, the construction apparatus of the present invention has application in a wide variety of environments; avoids the pitfalls experienced with conventional devices; has particular utility when used in the case of sliding doors and the like; is less expensive than conventional devices; can rapidly and dependably be installed without undue instruction or supervision; is of durable and dependable construction so as to provide a long operational life with little or no repair or other attention; and is otherwise entirely successful in achieving its operational objectives.

Although the invention has been herein shown and described in what is conceived to be the most practical and preferred embodiment, it is recognized that departures can be made therefrom within the scope of the invention which is not to be limited to the illustrative details disclosed.

Having described my invention, what I claim as new and desire to secure by Letters Patent is:

1. A construction apparatus comprising a frame adapted to be mounted on a means of support; at least one work object, having a predetermined upper portion and lower portion; and means mounting the work object in supported relation on the frame by said upper portion or said lower portion for substantially lateral movement relative to the means of support in the performance of a work operation.

2. The construction apparatus of claim 1 wherein the work object is a door having the upper portion thereof mounted on said mounting means in suspended relation on the frame for said substantially lateral movement.

3. The construction apparatus of claim 1 wherein there are two work objects individually having upper portions mounted on the mounting means in suspended relation from the frame for said substantially lateral movement relative to the means of support.

4. The construction apparatus of claim 3 wherein the work objects are doors individually having said lower portions which are elevated in spaced relation to a floor surface and including a guide assembly mounted on the floor surface and extending upwardly therefrom to define two individual paths of travel each dimensioned individually to receive the lower portions of the doors for said lateral movement.

5. The construction apparatus of claim 4 wherein the doors are individually adapted for said lateral movement in suspended relation from the frame in said spaced relation to the floor surface along said individual paths of travel of predetermined length and said guide assembly is substantially centrally mounted relative to said predetermined length and is of shorter length than said predetermined length of the paths of travel.

6. The construction apparatus of claim 5 wherein said doors are suspended in overlapping relation to each other and individually adapted for movement to and from closed positions along said paths of travel in which the lower portions of said doors are only partially laterally received in the guide assembly whereby the lower portions of said doors are movable to and from their respective closed positions as guided by the guide assembly.

7. The construction apparatus of claim 6 wherein at least one of said doors mounts a mirror facing outwardly from the door in a predetermined direction.

8. The construction apparatus of claim 7 wherein both of the doors have mirrors individually mounted thereon facing in the same predetermined direction.

9. The construction apparatus of claim 8 in which said means of support is an opening to a closet or the like and wherein the doors in said closed positions cover said opening to the closet.

10. A construction apparatus for use in controlling access to the interior of a closet or the like through an opening communicating with said interior and in which said opening is bounded by a substantially horizontal upper member, a pair of side members and a floor surface, the construction apparatus comprising a frame member adapted to be mounted on the substantially horizontal upper member and having a length extending to said side members; a pair of track assemblies mounted on the frame member and having a length substantially the same as said horizontal upper member; a plurality of transporting assemblies mounted for movement along each of said track assemblies; a pair of doors having upper portions individually mounted in suspended, overlapping relation from said track assemblies for movement therealong and the door assemblies having lower portions extending toward the floor surface to lower edges disposed in adjacent spaced relation to said floor surface; a guide assembly adapted to be mounted on the floor surface; having a pair of paths of travel individually adapted to receive said lower edges of the doors in overlapping relation for movement along the pair of paths of travel to and from closed positions disposed in conveying relation to the opening of the closet or the like; and mirrors individually mounted on the doors facing outwardly from the opening of the closet for use in any positions along said paths of travel to and from said closed positions.
